(19) United States
(12) Patent Application Publication
(10) Pub. No.: US 2025/0363396 A1
(43) Pub. Date: Nov. 27, 2025

(54) SYSTEMS, APPARATUSES, METHODS, AND NON-TRANSITORY COMPUTER-READABLE STORAGE MEDIA FOR DATA-FREE ENHANCEMENT OF FOUNDATION MODEL REASONING ABILITY

(71) Applicant: HUAWEI TECHNOLOGIES CO., LTD., Shenzhen (CN)

(72) Inventors: Xin Zhe LI, Edmonton (CA); Feng Wen, Montreal (CA); Amirreza Kazemi, Montreal (CA); Jikun Kang, Montreal (CA); Xi Chen, Montreal (CA); Boxing CHEN, Montreal (CA)

(21) Appl. No.: 19/008,922

(22) Filed: Jan. 3, 2025

Related U.S. Application Data
(60) Provisional application No. 63/651,793, filed on May 24, 2024.

(51) Int. Cl. G06N 5/04

(52) U.S. Cl. CPC G06N 5/04

(57) ABSTRACT

A computerized method has the steps of: generating one or more queries from an input question; generating one or more outputs; and outputting an answer based on the one or more outputs. Said generating the one or more outputs has the steps of: for each query, forming a reasoning tree with the query being a root node and a current node, generating one or more candidates as leaf nodes of the current node, by inputting a reasoning path from the root node to the current node into a foundation model, searching the reasoning tree using an artificial intelligence model to select a leaf node as the current node, and repeating said generating the one or more candidate nodes and said searching the reasoning tree until a termination condition is met, and using an updated reasoning path from the root node to the current node as the output for the query.

### CROSS-REFERENCE TO RELATED APPLICATION

This application claims the benefit of U.S. Provisional Patent Application Ser. No. 63/651,793, filed May 24, 2024, the content of which is incorporated herein by reference in its entirety.

### FIELD OF THE DISCLOSURE

The present disclosure relates generally to systems, apparatuses, methods, and computer-readable storage media for foundation models such as large language models and, in particular, to systems, apparatuses, methods, and computer-readable storage media for enhancement of foundation model reasoning ability such as large language model reasoning ability.

### BACKGROUND

Foundation models (FMs) or language models (LMs) such as Large Language Models (LLMs) are computational models used for language generation and other natural language processing, such as text classification. Some LLMs may obtain these abilities by learning the statistical relationship between language tokens through intensive training procedures. With the rapid growth of model size, transformer-based LLMs have shown results in domains such as, for example, instruction following, coding assistance, and creative writing. Among these tasks, unlocking the rationality of LLMs to solve complex reasoning tasks remains a major challenge. Recent works have attempted to tackle this challenge through Supervised Fine-Tuning (SFT). By mixing crafted new reasoning data samples with original datasets, LLMs learn the underlying distributions of these samples and attempt to mimic the logic they have learned to solve unseen reasoning tasks. Although there is a performance gain, this method heavily relies on extensive training and requires extra data preparation.

### SUMMARY

According to one aspect of this disclosure, there is provided a computerized method comprising: generating one or more queries from an input question; generating one or more outputs for the one or more queries, each output corresponding to a respective one of the one or more queries; and outputting an answer based on the one or more outputs; wherein said generating the one or more outputs for the one or more queries comprises: for each query of the one or more queries, forming a reasoning tree with the query being a root node and a current node, generating one or more candidate nodes by inputting a reasoning path from the root node to the current node into a foundation model (FM), the one or more candidate nodes being appended to the current node as one or more leaf nodes of the reasoning tree, searching the reasoning tree using an artificial intelligence (AI) model to select a leaf node from the reasoning tree as the current node, and repeating said generating the one or more candidate nodes and said searching the reasoning tree until a termination condition is met, and using an updated reasoning path from the root node to the current node as the output for the query.

In some embodiments, said generating the one or more queries from an input question comprises: rephrasing the input question into one or more rephrased queries; and the one or more outputs comprise the input question and the one or more rephrased queries.

In some embodiments, said outputting the answer based on the one or more outputs comprises: outputting the answer as one of the one or more outputs selected based on scoring of the one or more outputs.

In some embodiments, said outputting the answer based on the one or more outputs comprises: outputting the answer as one of the one or more outputs selected using a majority voting method based on the one or more outputs.

In some embodiments, said generating the one or more candidate nodes comprises: generating a plurality of candidate nodes by repeatedly inputting the reasoning path from the root node to the current node into the FM.

In some embodiments, said generating the one or more candidate nodes comprises: generating a plurality of candidate nodes by repeatedly inputting the reasoning path from the root node to the current node into the FM and by using a predefined or predetermined template.

In some embodiments, said generating the plurality of candidate nodes comprises: in each of said repeatedly inputting, inputting the reasoning path from the root node to the current node into the FM to generate one candidate node; and if, in one of said repeatedly inputting, more than one node is generated, using one or more regular expressions to selected one of the generated more than one mode as said one candidate node.

In some embodiments, said searching the reasoning tree comprises: scoring each of the plurality of candidate nodes using the AI model.

In some embodiments, the AI model is a process-supervised reward model (PRM) or a reinforcement learning model.

In some embodiments, said searching the reasoning tree comprises: searching the reasoning tree using a beam search method or a Levin tree search (LevinTS) method.

According to one aspect of this disclosure, there is provided one or more processors functionally connected to one or more non-transitory, computer-readable storage media comprising computer-executable instructions, wherein the instructions, when executed, cause the one or more processors to perform any of the above-described method.

According to one aspect of this disclosure, there is provided a data-free search-based LLM reasoning enhancement. This may enhance LLM reasoning ability at inference time while requiring no extra data collection efforts nor fine-tuning computing overhead. The data-free search-based LLM reasoning enhancement provides query augmentation to create a reasoning forest consisting of multiple reasoning trees which may provide more robust reasoning outputs (forest search vs. tree search). Multiple reasoning candidates may be generated and evaluated for every reasoning step. This may provide enhanced reasoning performance with the ability to locate the correct a reasoning path among generated path.

According to one aspect, there is provided a method of enhancing a reasoning ability of a large language model (LLM). The method may comprise rephrasing a reasoning query into multiple rephrased queries, where each of the rephrased queries and the reasoning query serve as a root node of one of a multitude of reasoning trees, the multitude of reasoning trees forming a reasoning forest, traversing each tree of the reasoning forest starting from the root node of each tree, inputting a current visited node together with one or more previous nodes into the LLM to generate a next step of multiple steps of a reasoning path, wherein the step generation is repeated multiple times so as to generate multiple step candidates and scoring each step candidate of the multiple step candidates and, based on scores of the multiple step candidates and one or more previously traversed nodes.

In some embodiments, the scoring is based on a process-supervised reward model (PRM). In some embodiments, the method further comprises selecting one step candidate of the multiple step candidates or back-tracking to an upper level of a current tree. In some embodiments, the method further comprises a Levin tree search method.

In another aspect, there is provided an apparatus, wherein the apparatus comprises a processor and a memory storing one or more instructions that is capable of being run on the processor, and when the one or more instructions are run, the apparatus is enabled to perform any of the methods disclosed herein.

In another aspect, there is provided an apparatus, wherein the apparatus comprises a function or unit to perform any of the methods disclosed herein.

In another aspect, there is provided a computer readable storage medium, comprising one or more instructions, wherein when the one or more instructions are run on a computer, the computer performs any of the methods disclosed herein.

In another aspect, there is provided a non-transitory computer-readable medium storing instruction the instructions causing a processor in a device to implement any of the methods disclosed herein.

In another aspect, there is provided a device configured to perform any of the methods disclosed herein.

In another aspect, there is provided a processor, configured to execute instructions to cause a device to perform any of the methods disclosed herein.

In another aspect, there is provided an integrated circuit configure to perform any of the methods disclosed herein.

According to one aspect of this disclosure, there is provided a module comprising: one or more circuits for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus configured to perform the above-described method.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform the above-described method.

According to one aspect of this disclosure, there is provided one or more computer-readable storage media storing a computer program, wherein, when the computer program is executed by an apparatus, the apparatus is enabled to implement the above-described method.

According to one aspect of this disclosure, there is provided a computer program product including one or more instructions, wherein, when the instructions are executed by an apparatus, the apparatus is enabled to implement the above-described method.

According to one aspect of this disclosure, there is provided a computer program, wherein, when the computer program is executed by a computer, an apparatus is enabled to implement the above-described method.

According to one aspect of this disclosure, there is provided a system comprising a node for performing the above-described method.

According to one aspect of this disclosure, there is provided an apparatus for implementing the method in any possible implementation of the foregoing aspects.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM); and

FIGS. 5A to 5C are schematic diagrams showing different types of the LLMs shown in FIG. 4, wherein

FIG. 5A is a schematic diagram showing an encoder-based LLM,

FIG. 5B is a schematic diagram showing a decoder-based LLM, and

FIG. 5C is a schematic diagram showing an encoder-decoder-based LLM;

FIG. 6 is a diagram showing example methods used for LLM reasoning enhancement;

FIG. 7 is a schematic diagram showing an example of the workflow of an enhanced reasoning method performed by the system shown in FIG. 1, according to some embodiments of this disclosure;

FIGS. 8A to 8D is a schematic diagram showing an example of performing the enhanced reasoning method shown in FIG. 7;

FIG. 9 is a flowchart diagram showing an enhanced reasoning method 300, according to some embodiments of this disclosure;

FIG. 10 is a schematic diagram showing an example of the system shown in FIG. 1 implementing the enhanced reasoning method shown in FIG. 7, according to some embodiments of this disclosure; and

FIG. 11 is a schematic diagram showing an example of the system shown in FIG. 1 implementing the enhanced reasoning method shown in FIG. 7, according to some other embodiments of this disclosure.

### DETAILED DESCRIPTION

Embodiments disclosed herein relate to artificial intelligence (AI) systems and apparatuses using foundation models (FMs) or language models (LMs) such as large language models (LLMs). The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### A. System Structure

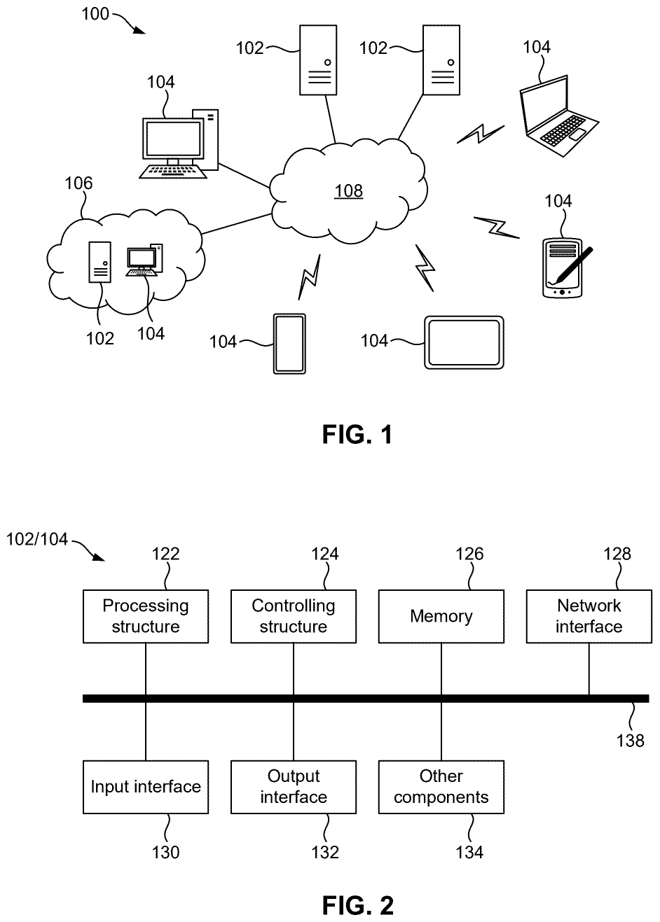

Turning now to FIG. 1, an exemplary computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

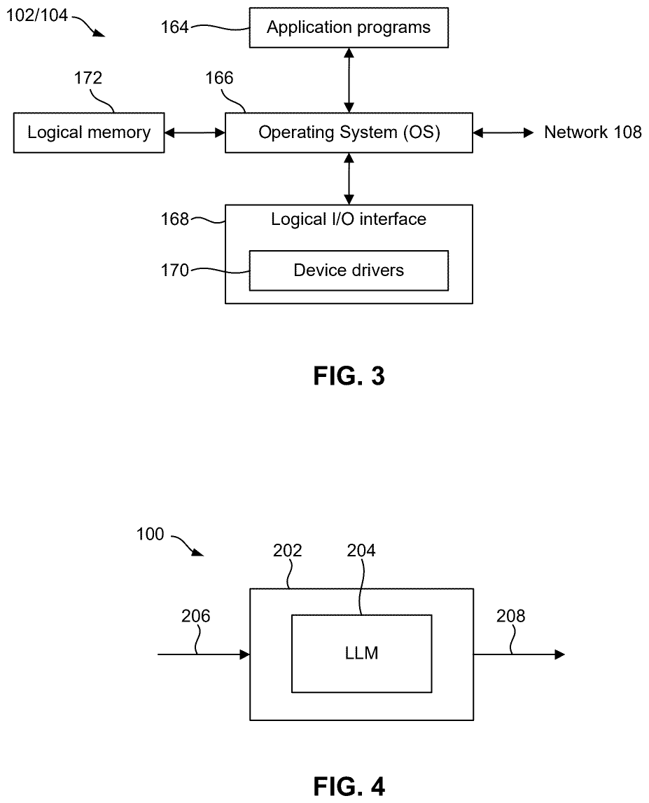

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Large Language Model

In some embodiments, the computer network system 100 executes an artificial intelligence (AI) engine (for example, in the form of one or more software programs). As shown in FIG. 4, the AI engine 202 comprises a FM such as an LLM 204 (which is used as an example in the following description) for processing input 206 (also called “prompt”; for example, natural language input in the form of text, image, voice, and/or the like), recognizing and interpreting the input 206 for generating the output 208 in suitable forms (for example, in form of text, image, audio, video, and/or the like) as the response to the prompt 206. As those skilled in the art will appreciate, foundation models such as LLMs are neural network models that learn the semantics and syntax of language by encoding (sub) words into vector representations.

More specifically, a FM such as an LLM is a computational model that may rely on a large number of computing parameters to perform general purpose text generation and other language tasks such as text classification. LLMs may obtain these abilities by learning the statistical relationship between language tokens through intensive training procedures. A training procedure of an LLM is a procedure during which an LLM learns the statistical relationship between language tokens, usually through auto-regressive learning on some corpus, e.g., predicting the next token given the previous tokens. During this procedure, the ground truth of the tokens to be predicted is known and the errors between the prediction and the ground truth may be iteratively minimized via back-propagation.

Examples of LLMs include ChatGPT (a generative artificial intelligence chatbot developed by OpenAI of San Francisco, California, USA), GPT-4 (Generative Pre-trained Transformer 4, which is a multimodal large language model created by OpenAI of San Francisco, California, USA), LLAMA (a family of autoregressive large language models released by Meta AI of Astor Place, New York City, New York, USA), and PaLM2 (a transformer-based large language model developed by Google AI of Mountain View, California, USA), which have proven to achieve state-of-the-art (SOTA) performance in various natural language processing (NLP) tasks.

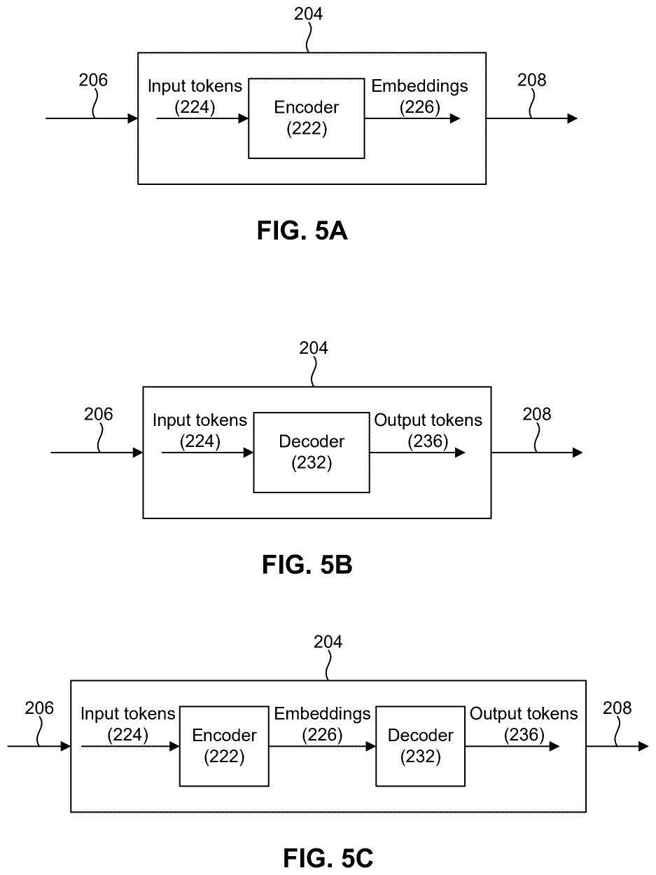

FIGS. 5A to 5C are schematic diagrams showing different types of LLM 204. These figures are simplified diagrams for showing the different types of LLM 204 only, and those skilled in the art will understand that the LLM 204 may also comprise other functional modules that are not shown in these figures.

FIG. 5A shows an encoder-based LLM 204 comprising an encoder 222 which processes the input tokens 224 (which are the units (for example, words or characters partitioned from the prompt 206) and generates embeddings 226 (which are then used to generate the output 208). As those skilled in the art understand, embeddings are high-dimensional vectors encoding semantic contexts and relationships of data tokens.

Most popular LLMs 204 are decoder-based (or “decoder-only”) models. As shown in FIG. 5B, the LLM 204 may be an LLM comprising a decoder 232 which processes the input tokens 224 and generates output tokens 236 (which are then used to generate the output 208). More specifically, the decoder-only LLM 204 learns to produce a distribution for the next token in a sequence given past context as input.

As shown in FIG. 5C, the LLM 204 may be an encoder-decoder-based LLM comprising an encoder 222 which processes the input tokens 224 and generates embeddings 226, and a decoder 232 which generates output tokens 236 based on the embeddings 226 (which are then used to generate the output 208).

LLMs may use various procedures. For example, a Supervised Fine-Tuning (SFT) procedure of an LLM is a procedure used to fine-tune a general purpose LLM toward some task-specific domains via further training the LLM on some task-specific data.

An inference procedure of an LLM is a procedure where an LLM replies to a query without knowing the ground-truth answer.

The reasoning ability of an LLM is the ability of an LLM to produce outputs that align with logical reasoning and to solve reasoning tasks such as math reasoning and common-sense reasoning.

The enhancement of LLM reasoning ability can be conducted in a training procedure, an SFT procedure or during an inference procedure. While enhancement during a training or SFT procedure requires extra collection and labelling efforts on reasoning-oriented data, the enhancement during an inference procedure may require much less or even no extra data collection efforts.

A Process-supervised Reward Model (PRM) is a computing model that evaluates and scores the quality of intermediate steps in a reasoning path.

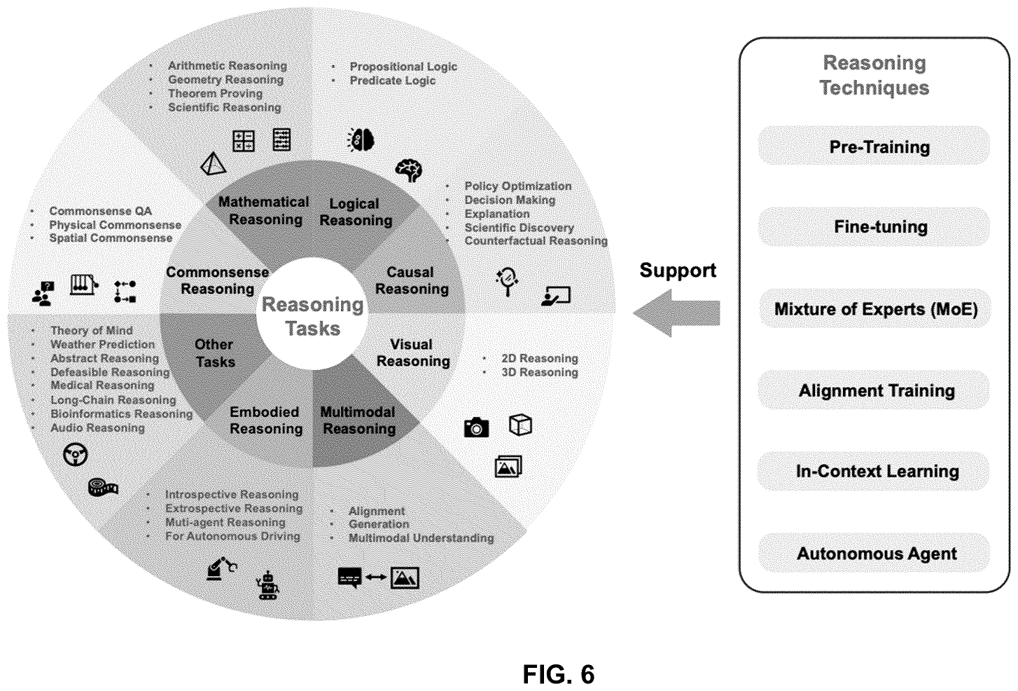

In prior art, various methods have been used for LLM reasoning enhancement. FIG. 6 shows some examples. Generally, prior-art methods have been used on LLM reasoning in different stages of the LLM life cycle. For example, in pre-training, training and fine-tuning stages, extra reasoning related data can be collected and labelled for reasoning enhancement purpose. In the alignment training stage, human feedback can be collected to form preference signals, which may be used to refine the reasoning of LLM toward human preferences. In-context learning is a method conducted during an inference stage. Examples of reasoning can be combined with a prompt, so that the LLM may be able to refer to these examples when answering a reasoning query of a user. This method also requires collecting suitable examples.

In prior art, multistep reasoning has been used in LLMs, wherein LLM reasoning may consist of breaking down complex questions into a series of sequential intermediate steps before arriving at the final answer. For example, several methods have been proposed to enhance LLM reasoning capability, ranging from fine-tuning the base model to chain-of-thought (CoT) prompting and its variants. Specifically, CoT prompting can enhance LLM reasoning in few-shot and zero-shot settings. Such in-context improvement grounds in the decoder architecture of LLMs, however a single reasoning path (that is, greedy decoding) often suffers from stochasticity and is not diverse enough for complex reasoning tasks. To mitigate this, some methods have been proposed to generate a diverse set of reasoning paths and perform a majority voting to reach a consistent reasoning. Similarly, solution verifiers have been used to prompt LLM for self-verification in order to determine the quality of generated reasoning paths.

Despite their benefits, recent studies found that LLMs often make unfaithful reasoning, meaning that generated reasoning chain does not reflect how the model reaches the answer. This sheds light to the importance of verifying each step of the reasoning chain. Moreover, the linear COT does not take different alternatives into account at the generation time, and there is no mechanism to evaluate the current generated chain and possibly look ahead or backtrack. The methods described herein differ from the CoT and outcome verification studies in that, for example, step-level feedback is used to search for a reasoning path within a tree-of-thought (ToT). In some embodiments of the current application, step-level feedback is not employed in post-hoc generation manner to filter out reasoning paths, but it may facilitate control over the generation process.

Feedback-guided tree search has also been used for LLM reasoning. In a ToT framework, the path from root to each node represents a reasoning chain, branches represent alternative reasoning steps, and the terminal nodes are the final reasoning answer. Various methods have been proposed to find a good reasoning path within the tree, each employing a distinct heuristic and search algorithm. The most straightforward way to evaluate the generated steps is to prompt the LLM itself to assess them such as coupling with breadth/depth first search, coupling with Monte Carlo tree search and coupling with beam search. However, recent studies have shown that LLMs struggle to evaluate themselves and may rectify their initial responses without any external feedback. On the other hand, studies have been proposed to learn value function to estimate the value of the current reasoning chain (state), and employ it as a heuristic within a Monte Carlo tree search method. Process-supervised Reward Model (PRM) has been utilized during inference with A*-like tree search.

In the following various embodiments of enhanced reasoning methods are disclosed. The methods disclosed herein may be simpler and more efficient and robust because, by using the methods disclosed herein,
a reasoning forest consisting multiple reasoning trees may be created,
reward sparsity and sample complexity issues of value function approximation are not dealt with, and
incorporating PRM as heuristic in Levin tree search (LevinTS) may guarantee a computation cost upper bound in finding the correct reasoning path.

The notions and concepts used in the embodiments disclosed herein are as follows:

An LLM is defined as an AI model parameterized by θ, denoted as G(⋅; θ). A reasoning tree T is a set of sequences of actions. The leaves L(T) of the tree are the set of nodes n∈T such that T contains no descendant of n.

The reasoning tree searching process is formulated as a Markov Decision Process (MDP) denoted as M=(S, A, T, R, π), wherein S, A, T, R, and π are the state space, the action space, the reasoning tree, the reward function, and the policy, respectively.

The action space A is defined as a set of token sequences a₀, a₁, a₂, . . . (where the set comprises a plurality of action sequence primitives), each token sequence representing an action. Specifically, an action is a reasoning step generated by an LLM. For example, in some embodiments, the action is a sentence generated by an LLM.

The state space S is defined as a sequence of actions s₁, s₂, . . . , (that is, an ordered combination of actions used in the reasoning). The current state is the concatenation of past actions s, =a₀⊕a₁⊕ . . . ⊕aₜ₋₁, where ⊕ is the concatenation.

In the reasoning tree T, the node n is defined as the state s, and the edge is the action ar.

The reward function, R, assigns a reward value, rₜ=R(sₜ,aₜ), to each state-action pair, and the transition function, V, determines the probability of transitioning from one state to another, where sₜ₊₁=V(sₜ,aₜ). Since a state is a sequence of chosen actions, in these embodiments, sₜ₊₁=sₜ⊕aₜ. The policy π is Markovian and is defined as which child node to be chosen in accordance with the policy π, that is, aₜ=π(sₜ), which may be dependent on the search algorithm or method used by the enhanced reasoning methods in various embodiments.

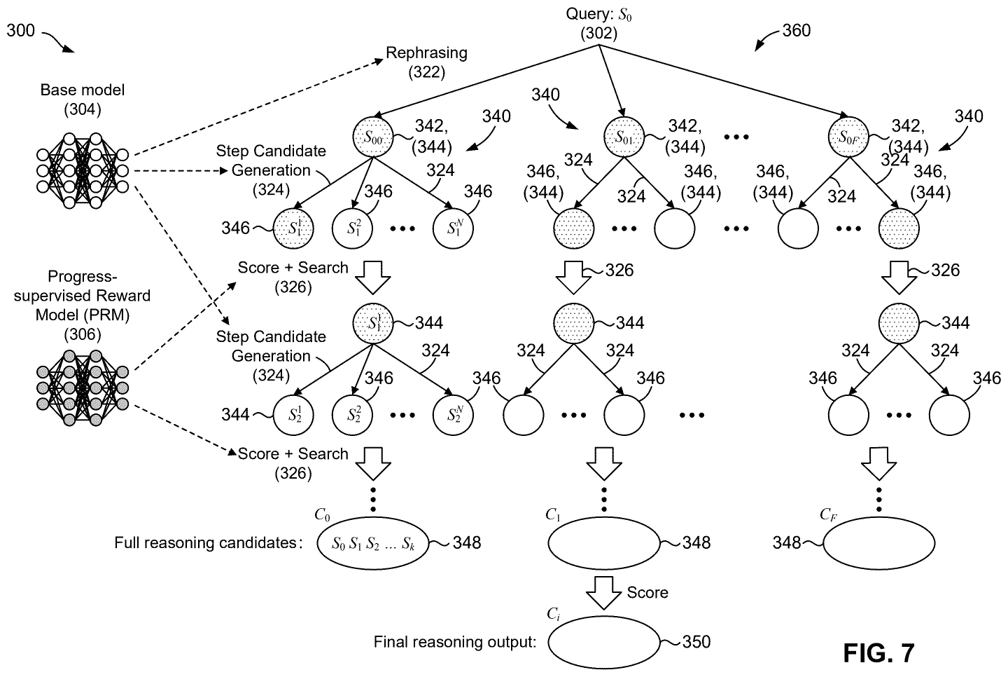

FIG. 7 is a schematic diagram showing an example of the workflow of an enhanced reasoning method 300, according to some embodiments of this disclosure. As shown, given a reasoning query or prompt 302 (also denoted as an action node S₀ in FIG. 7), the enhanced reasoning method 300 performs the following operations:

### Query Augmentation 322:

At this step, the enhanced reasoning method 300 rephrases the reasoning query 302 into F different rephrased queries 342 (also denoted as action nodes S₀₁, S₀₂, . . . , S_{0F}) using the pre-trained base LLM 304, wherein F≥1 is an integer.

The original reasoning query 302 and the rephrased queries 342 are then combined (which are denoted S₀₀, S₀₁, S₀₂, . . . , S_{0F} in FIG. 7, wherein S₀₀ is the original reasoning query S₀ (that is, S₀₀=S₀), and is also denoted 342 for ease of illustration). Each these queries 342 (including the original reasoning query S₀₀=S₀) is used as a root node of a reasoning tree 340. In this way, a reasoning forest 360 of the original query is created.

The enhanced reasoning method 300 then starts from each root node 342 and iteratively builds a plurality of reasoning paths using a next-level candidate generation step 324 and a score and search step 326 in each iteration. As there are F+1 root nodes, the enhanced reasoning method 300 expands the search tree F+1 times, and the number of generations per step is a hyperparameter (such as 4, 8, 16, or the like).

### Next-Level Candidate Generation 324:

Note that, in these embodiments, the currently visited node (or simply the “current node”) 344 (which may be a root node 342 when the root node is used as the current node) includes the entire reasoning path so far (that is, it is a concatenation of action sequences from the root node to the current node). At this step, the enhanced reasoning method 300 inputs the current node 344 into a pre-trained base LLM 304 to generate next-level candidate nodes 346 (also called “candidates” or “rationales”) for the next level of the reasoning path (note that a reasoning path may contain multiple levels). This next-level candidate generation step 324 is repeated N times for the current node 344, thereby generating a total of N next-level candidate nodes 346 for the current reasoning level.

In one example, the enhanced reasoning method 300 at step 324 may use a prompt template (see EXAMPLE 1) to facilitate the generation of the N next-level candidate nodes 346, wherein, to construct a prompt, {question} is replaced with the actual question (that is, query S₀ᵢ), and {answer} is replaced with the prior reasoning steps (that is, the concatenation of the sequence of actions (reasoning steps) along the path shared by the root node and the current node).

### Example 1: Next-Level Candidate Generation Prompt Template

[INST] <<SYS>> Below is an instruction that describes a task.
Write a response that appropriately completes the request. Output
each step in a separate line, and explicitly state the final answer
after the final step following the format. “The answer is:” <</SYS>>
Instruction: {question}[/INST]
Response: Let's think step by step. {answer}

In some embodiments where the model 304 may output multiple consecutive candidates simultaneously at a step 324, the enhanced reasoning method may employ regular expressions to trim the output sentence, retaining only one candidate (to ensure that the N repeats of the step 324 generate N candidates).

### Score and Search 326:

At this step, a pre-trained AI model 306 such as a PRM is used to score the N next-level candidates 346 generated in the current iteration. Based on the scores of the N next-level candidate nodes 346 in the current iteration and the scores of other leaf nodes in the reasoning tree 340, the enhanced reasoning method 300 may select a leaf node using a suitable tree search algorithm or method such as a beam search algorithm or a modified LevinTS algorithm (described in more detail later). The selected leaf node may be one of the N next-level candidates 346 in the current iteration, or may be a leaf node back-tracked to an upper level of the reasoning tree 340 (described in more detail later).

In some embodiments, the enhanced reasoning method 300 uses a pre-trained PRM P as the reward function R. As those skilled in the art understand, in prior art, a PRM P takes the state as input and outputs a scalar rₜ=P(sₜ), where rₜ∈[0, 1].

In these embodiments, the PRM P is used as the estimator of the reward function when the action is one (1) (that is, select). In other words, the PRM P in these embodiments is a fine-tuned LLM that takes a scoring role. The inputs of the PRM P are states and actions at the current timestep. The node value is then calculated using rₜ=R(sₜ,aₜ)=P(sₜ⊕aₜ), which evaluates the likelihood that the proposed next-level candidate 346 is correct, based on the question and the accumulated reasoning steps.

Thus, the enhanced reasoning method 300 incorporates the Markovian property by scoring each reward based on previous observation trajectories. Consequently, it is easy to show that the outcome reward model (ORM) is a specific instance of the framework disclosed herein, where rewards are evaluated at the final timestep.

After evaluating the next-level candidate nodes 346, the enhanced reasoning method 300 identifies the optimal reasoning path within the current reasoning tree 340 by selecting an optimal leaf node, which may be one of the N next-level candidate nodes 346 or another leaf node in the reasoning tree 340. The selected leaf node becomes the current node 344 in the next iteration.

The enhanced reasoning method 300 may perform more iterations by repeating the above-described steps 324 and 326 until the final answer is discovered, or until other suitable conditions are met (such as the maximum computational resources are exceeded, a maximum number of iterations have been performed, and/or the like).

A final reasoning path 348 comprising a full set of selected reasoning candidates is then obtained. In those embodiments where F=1, the final reasoning path 348 is the final reasoning output 350.

In those embodiments where F>1, after the final reasoning paths 348 for all reasoning trees 340 are obtained, the final reasoning paths 348 are scored to select a best one as the final reasoning output 350.

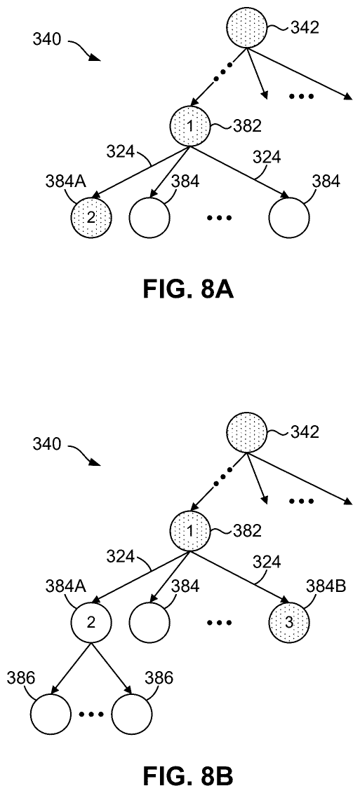

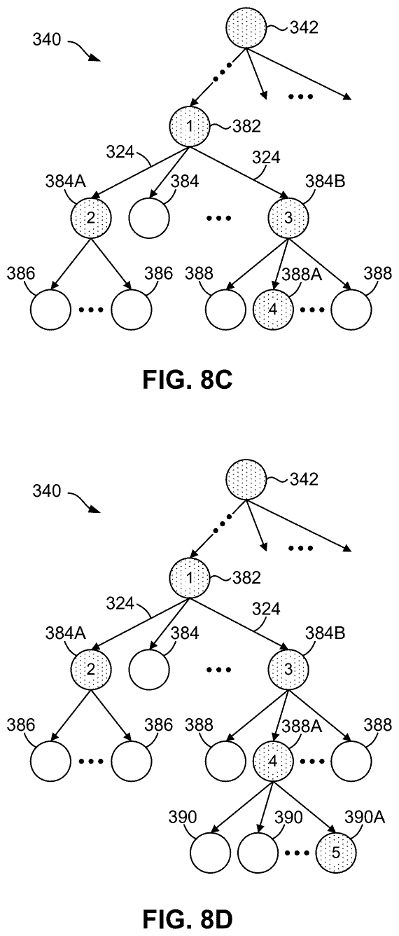

Those skilled in the art will appreciate that, when performing the enhanced reasoning method 300, or more specifically, when searching the reasoning tree 340, the selected leaf node may back-track to an upper level of the reasoning tree 340. FIGS. 8A to 8D illustrate an example. In these figures, the numbers in the node circles represent the order of node selection, and the shaded circles represent the nodes along the reasoning path.

As shown in FIG. 8A, in a certain iteration, the node 382 is selected. Then in the next iteration, the enhanced reasoning method 300 performs the next-level candidate generation step 324 to generate N candidate nodes 384 (including the node 384A), which are added to the reasoning tree 340 as the children nodes of the node 382. After performing the score and search step 326, the candidate node 384A is selected.

As shown in FIG. 8B, in the next iteration, the enhanced reasoning method 300 performs the next-level candidate generation step 324 to generate N candidate nodes 386, which are added to the reasoning tree 340 as the children nodes of the node 384A. After performing the score and search step 326, none of the nodes 386 are selected. Rather, the search algorithm selects the leaf node 384B is selected (that is, the selected leaf node 384B back-tracks to the upper level of the reasoning tree 340). As the selected node 384B is not a leaf node of the node 384A, the node 384A is then not a member of the reasoning path, while the selected node 384B becomes a member of the reasoning path.

As shown in FIG. 8C, in the next iteration, the enhanced reasoning method 300 performs the next-level candidate generation step 324 to generate N candidate nodes 388, which are added to the reasoning tree 340 as the children nodes of the node 384B. After performing the score and search step 326, the node 388A is selected.

As shown in FIG. 8D, in the next iteration, the enhanced reasoning method 300 performs the next-level candidate generation step 324 to generate N candidate nodes 390, which are added to the reasoning tree 340 as the children nodes of the node 388A. After performing the score and search step 326, the enhanced reasoning method 300 determines that selecting the node 390A (that is, the reasoning path from the root node 342 to the leaf node 390A) solves the problem. The enhanced reasoning method 300 then outputs the final answer, and the procedure is completed. In some embodiments, the enhanced reasoning method 300 may also output the entire reasoning path.

ALGORITHM 1 below shows an example of an implementation of the enhanced reasoning method 300.

ALGORITHM 1: EXAMPLE OF THE ENHANCED REASONING METHOD
Algorithm 1 M* Algorithm

```
Require: Question q, pre-trained PRM function R( ), level L, language model G( ), step
  samples N, an empty reasoning tree;
  while l < L and question not answered do
    for n ∈ N do [symbol]  Sample N answers from LLM
      ${a}_{t + 1}^{n} = G ( {s}_{t} , {a}_{t} )$ [symbol]   Each answer is generated based on questions and previous steps
      Add a child node to the reasoning tree, the node value is c_{child} = cₚₐᵣₑₙₜ + R(sₜ, aₜ)
    end for
    Use the tree search algorithm (e.g. beam search or LevinTS) to search the next node sₜ₊₁.
    if sₜ₊₁ solves the problem then
      return sₜ₊₁. [symbol]  The final reasoning path
    end if
  end while
```

In various embodiments, the enhanced reasoning method 300 may use any suitable search algorithm to identify the optimal reasoning path within the current reasoning tree 340, and thus does not rely on a specific search algorithm.

For example, in some embodiments, the enhanced reasoning method 300 uses a beam search algorithm or method to identify the optimal reasoning path within the current reasoning tree 340.

Similar to how a language model generates tokens, the enhanced reasoning method 300 uses the beam search algorithm for traversing a reasoning tree 340. Starting from each root node 342, the enhanced reasoning method 300 generates a fixed number of samples and append them as children nodes 346 (that is, the next-level candidate nodes). Then, the enhanced reasoning method 300 selects, from these next-level candidate nodes, the node with the highest score, that is, π(sₜ)=arg max_{N(s}_{ₜ}₎r(sₜ), where N represents all children nodes of node sₜ. The process continues until reaching a leaf node (that is, the final answer), or until other suitable conditions are met (such as the maximum tree depth is reached). An example of the beam search algorithm used in the enhanced reasoning method is shown in ALGORITHM 2.

ALGORITHM 2: EXAMPLE OF THE BEAM SEARCH ALGORITHM
USED IN THE ENHANCED REASONING METHOD

Require: Question s₀, pre-trained PRM function [symbol] ( ), language model G( ),

| | step samples N. an empty reasoning tree, and |
|---|---|
| | the maximum search level L; |
| 1: | while l < L and question not answered |
| | do |
| 2: | for n ∈ N do [symbol] Sample N answers |
| | from LLM |
| 3: | ${a}_{l + 1}^{n} = G ( {s}_{l}^{*} )$ |
| | [symbol] Each answer is generated based on questions and previous steps |
| 4: | $Add a child node {s}_{l + 1}^{n} to the$ |
| | reasoning tree, where the node value is calculated |
| | $as c ( {s}_{l + 1}^{n} ) = c ( {s}_{l}^{*} ) + 𝒫 ( {s}_{l}^{*} , {a}_{l} )$ |
| 5: | end for |
| 6: | ${s}_{l + 1}^{*} max ( {s}_{l + 1}^{n} )$ |
| 7: | $if {s}_{l + 1}^{*} solves the problem or l equals$ |
| | the maximum search level L then |
| 8: | return the whole reasoning path |
| | $and final answer {s}_{l + 1}^{*} .$ |
| 9: | else |
| 10: | l = l + 1 |
| 11: | ${s}_{l}^{*} = {s}_{l + 1}^{*}$ |
| 12: | end if |
| 13: | end while |

As those skilled in the art understand, the beam search is a greedy method as it only chooses the best values according to the node value. This method guarantees the linear time tree search time complexity O(n) but does not guarantee to find the optimum reasoning paths.

In some embodiments, the enhanced reasoning method 300 uses a modified LevinTS algorithm or method guided by a searching policy with the time guarantee, to identify the optimal reasoning path within the current reasoning tree 340. As those skilled in the art understand, LevinTS is a best-first tree search algorithm relying on a cost function.

Let T be the current search tree 340. The node selection policy for a leaf node n∈L(T) is defined as:

$$π ( n ) := \frac{{e}^{P ( n )}}{{\sum }_{j = 1}^{\vert N ( T ) \vert} {e}^{P ( {n}_{j} )}} ,$$

where N is all children nodes 346 of node n in the current search tree T. In these embodiments, the depth of a node d(n) is modified from the conventional LevinTS to the LLM reasoning setting and is defined as d(n):=e^{τ·i}, where i is the number of tokens in the reasoning path corresponding to node n, and r is a temperature parameter. Then the cost function is defined as

$$\frac{{e}^{τ \cdot i ( n )}}{π ( n )} .$$

In other words, the modified LevinTS algorithm expands all nodes by increasing order of

$$\frac{d ( n )}{π ( n )} ( \cdot ) .$$

THEOREM 1 below shows that LevinTS started at a root node expands at most

$$\frac{{e}^{τ \cdot i ( n )}}{π ( n )}$$

nodes before reaching leaf node n. In these embodiments, the modified LevinTS algorithm guarantees to find a best path with a limited computation complexity, since the maximum degree of the tree and the number of candidates for node expansion are fixed.

### Theorem 1: Upper Bound of the Modified LevinTS Method

Let N_{g} be a set of target nodes, and let the depth of a node n be defined as d(n)=e^{τ·i}. Then, the modified LevinTS with a policy π ensures that the number of node expansions N(Modified_LevinTS,N_{g}) before reaching any of the target nodes is bounded by:

$$N ( Modified\_LevinTS , {N}_{g} ) \leq {min}_{n ∈ {N}_{g}} \frac{d ( n )}{π ( n )} .$$

An example of the modified LevinTS algorithm used in the enhanced reasoning method is shown in ALGORITHM 3.

ALGORITHM 3: EXAMPLE OF THE MODIFIED LEVINTS
ALGORITHM USED IN THE ENHANCED REASONING METHOD

| | Require: A node set [symbol] that have been expanded, and a node |
|---|---|
| | set [symbol] be the set of non-yet-expanded children of expanded nodes; |
| 1: | [symbol] := θ |
| 2: | [symbol] := s₀ |
| 3: | while [symbol] ≠ θ do |
| 4: | $n := arg {min}_{n ∈ ℱ} \frac{d ( {s}_{l}^{n} )}{softmax ( 𝒫 ) ( {s}_{l}^{n} )}$ |
| 5: | [symbol] := [symbol] \{n} |
| 6: | ${a}_{l + 1}^{n} = G ( {s}_{l}^{*} )$ |
| 7: | $if {s}_{l + 1}^{*} solves the problem or l equals$ |
| | the maximum search level L then |
| 8: | return the whole reasoning path |
| | $and final answer {s}_{l + 1}^{*} .$ |
| 9: | end if |
| 10: | if ∃n′ ∈ [symbol] : (T(n′) = s) ∧ (R(n′) ≥ R(n)) then |
| 11: | Continue |
| 12: | end if |
| 13: | $𝒱 := 𝒱 ⋃ {s}_{l}^{{n}^{′}}$ |
| 14: | $ℱ := ℱ ⋃ 𝒞 ( {s}_{l}^{n} )$ |
| | [symbol] C(·) is the set of children nodes |
| 15: | end while |

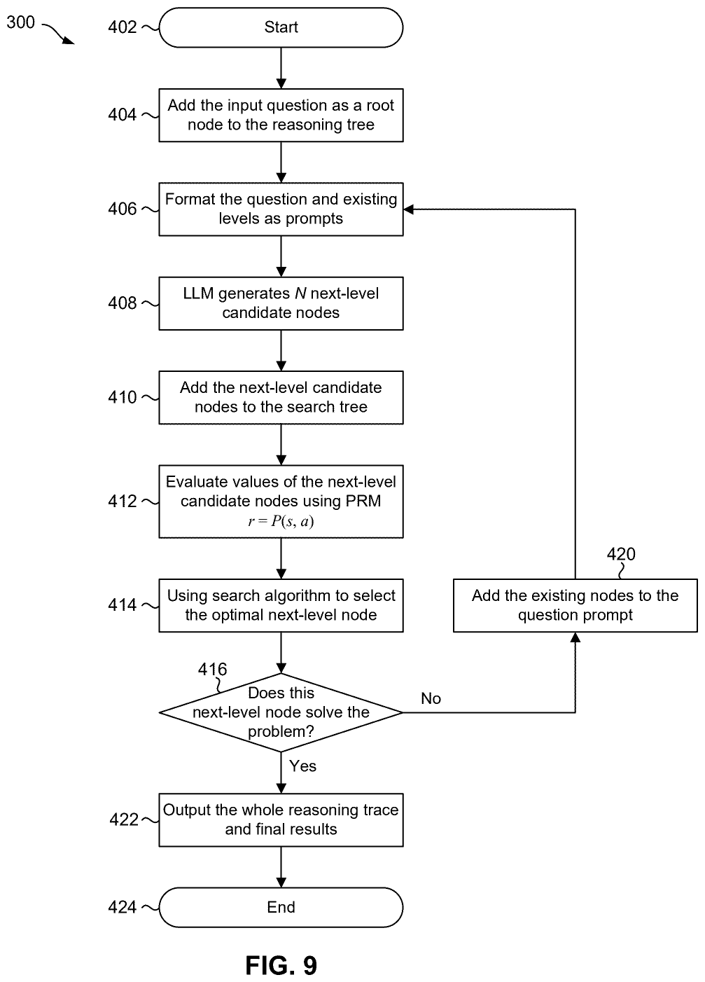

FIG. 9 is a flowchart diagram showing an enhanced reasoning method 300, according to some embodiments of this disclosure.

After the enhanced reasoning method 300 starts (step 402), the input question or prompt is added as a root node to a reasoning tree (step 404). Then, the question and the existing reasoning steps of the reasoning tree are formatted as prompts to an LLM (step 406). Accordingly, the LLM generates N next-level candidate nodes (step 408).

The next-level candidate nodes are then added to the search tree (step 410), and a PRM r=P(s,a) is used to evaluate the values of the next-level candidate nodes (step 412). At step 414, a search algorithm is used to select the optimal next-level node based on the value evaluation obtained at step 412. At step 416, the enhanced reasoning method 300 checks if any next-level node solves the problem. If no next-level node solves the problem (the “No” branch of step 416), the existing nodes are added to the question prompt (step 420), and the procedure goes back to step 406 for performing the next iteration.

If, at step 416, a next-level node solves the problem (the “Yes” branch of step 416), the enhanced reasoning method 300 outputs the entire reasoning trace (that is, the entire reasoning path) and the final results (step 422). The procedure then ends (step 424).

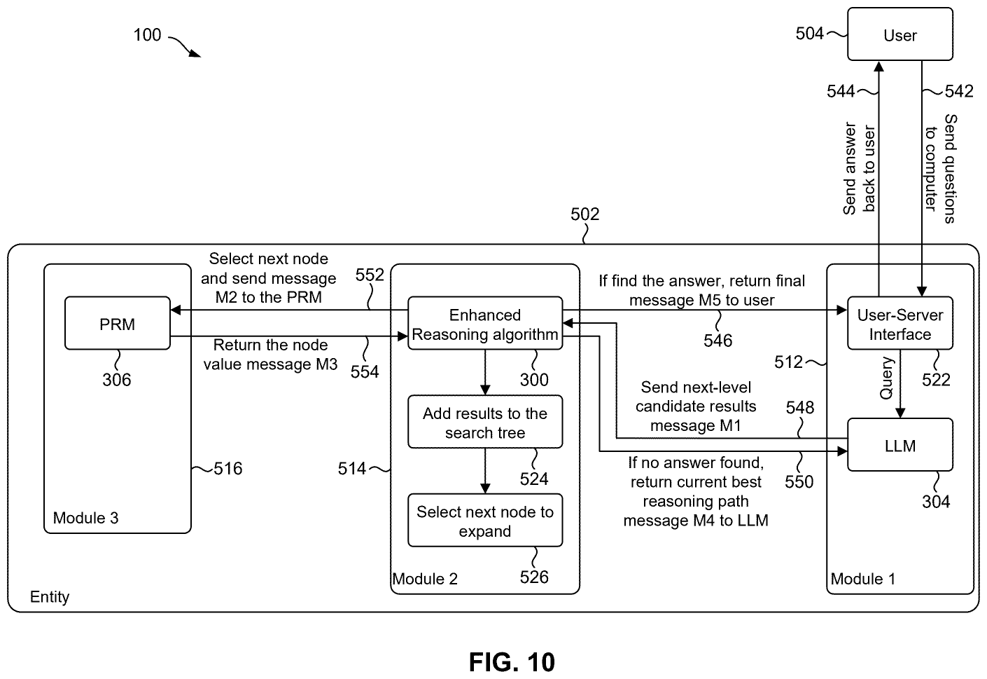

FIG. 10 is a schematic diagram showing an example of the system 100 implementing the enhanced reasoning method 300, according to some embodiments of this disclosure. In these embodiments, the system 100 is a single-entity system comprising a single computing device 502 such as a server computer 102 or a client computing device 104 for interacting with a user 504. The computing device 504 comprises three modules 512 to 516. TABLE 1 shows some example messages used in the protocol of the system 100 in these embodiments and their formats.

TABLE 1
EXAMPLE MESSAGES IN FIG. 10 AND FORMATS THEREOF

| | |
|---|---|
| M1: Level-candidate message | 8-bit header + a up-to-200 tokens content |
| M2: PRM query message | 8-bit header + up-to-200 tokens content |
| M3: Node value message | 8-bit header + up to 100 binary values |
| M4: Best-effort path message | 8-bit header + a up-to-1000 tokens content |
| M5: Final answer message | 8-bit header + a up-to-1000 tokens content |

The first module 512 mainly serves as the interface between the system 100 and the user 504, and comprises a user interface 522 and a base LLM 304. The first module 512 may receive the query 302 (see FIG. 7) from the user 504 to the user interface 522 (indicated by the arrow 542), use the base LLM 304 to rephrase the query 302 to create root nodes 342 for the reasoning forest 360, send them as the message M1 from the base LLM 304 to the second module 514 (indicated by the arrow 548) for the reasoning procedure, collect the final reasoning path in the final message M5 (indicated by the arrow 546) once the final answer is found, and shares it back to the user 544 (indicated by the arrow 544). The base LLM 304 of the first module 512 also receives the current best reasoning path in the message M4 (indicated by the arrow 550) if no answer found.

The second module 514 runs the core reasoning and search part of the entity 502. For each reasoning tree 340, it may run the enhanced reasoning method 300, during which the second module 514 may query the base LLM 304 in the first module 512, and receive multiple level-candidate messages M1 (indicated by the arrow 548) containing different level candidate nodes 346 for the current node 344. The second module 514 then asks the PRM 306 in the third module 516 to score these candidate nodes 346 by sending multiple M2 messages to the third module 516 (indicated by the arrow 552), and collect one combined reply message M3 from the third module 516 (indicated by the arrow 554). The second module 514 adds these candidate nodes 346 to the reasoning tree 340 (box 524), and, based on this scoring, the second module 514 determines whether or not the query 302 has been successfully answered. If yes, the second module 514 returns the reasoning path in message M5 as the final answer to the first module 512 (indicated by the arrow 546). If not, the second module 514 finds a node to create the best-effort reasoning path so far, and keep expanding the reasoning tree 340 (box 526). If the number of the reasoning levels reach a pre-defined threshold, the second module 514 returns the best-effort reasoning path in message M4 to the first module (indicated by the arrow 550).

The third module 516 comprises a PRM 306 which receives multiple M2 messages (indicated by the arrow 552) containing the reasoning candidate nodes 346 of the current reasoning level. The third module 516 may use, for example, its PRM 306 to score these candidate nodes 346, and return a combined scoring message M3 to the second module (indicated by the arrow 554).

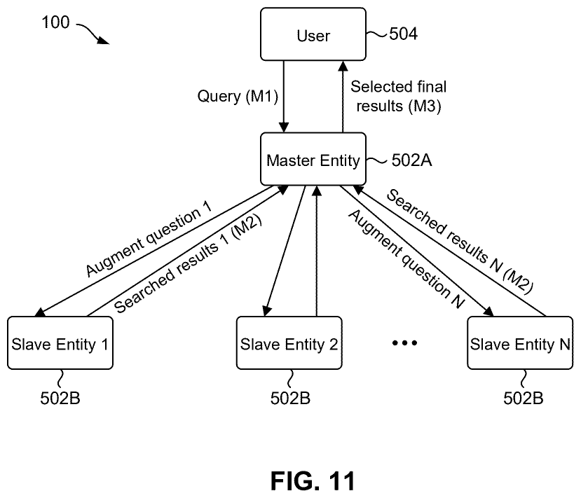

FIG. 11 is a schematic diagram showing an example of the system 100 implementing the enhanced reasoning method 300, according to some embodiments of this disclosure. In these embodiments, the system 100 is a multi-entity system comprising a master entity 502A (such as a server computer 102) and a plurality of slave entities 502B (such as a plurality of client computing devices 104 and/or a plurality of server computers 102). The master entity 502A serving as the interface between the system 100 and the users 504. Each slave entity 502B implements the enhanced reasoning method 300. TABLE 2 shows example messages used in the protocol of the system 100 in these embodiments and their formats.

TABLE 2
EXAMPLE MESSAGES IN FIG. 11 AND FORMATS THEREOF

| | |
|---|---|
| M1: User query | 8-bit header + a up-to-200 tokens content |
| M2: Rephrased query | 8-bit header + up-to-200 tokens content |
| M3: Reasoning result of a rephrased query | 8-bit header + a up-to-1000 tokens content |
| M4: Final answer | 8-bit header + a up-to-1000 tokens content |

The user 504 queries the master entity 502A with message M1. The master entity 502A may augment the query to multiple questions (M2's) and send them to slave entities 502B. Each slave entity 502B may search the results and returns an optimal result (M3's) to the master entity 502A as described above and similar to that shown in FIG. 10. The master entity 502A may use, for example, the majority voting method to find the final answer and return to user (M4).

In some embodiments, the scoring of the candidate steps may be based on human evaluation rather than a pre-trained PRM 306. In some embodiments, the scoring of the candidate steps could be based on reinforcement learning model rather than a pre-trained PRM 306. In some embodiments the generation of multiple reasoning candidates at each reasoning step may be modified by having only one reasoning candidate.

Thus, the enhanced reasoning methods disclosed herein enhance the LLM reasoning ability at inference time, requiring no extra data nor extra tuning of LLM parameters. In prior-art LLMs, output results may vary a lot when the same question is asked multiple time. By using the enhanced reasoning methods disclosed herein, output results remain the same for the same question, regardless how many times the question is asked.

The enhanced reasoning methods disclosed herein may also be used to enhance other LLM abilities. For example, it may be used to boost LLM abilities through search during inference time. For example, a personalized chatbot that can quickly tailor itself to the current user through a few interactions. TABLE 3 provides a comparison of various reasoning technologies, including Supervised Fine-Tuning (SFT) such as Low-Rank Adaptation (LoRA), MCTS-α (a Monte Carlo tree search method), AlphaLLM developed by Tencent AI Lab of Hongkong, China, and the enhanced reasoning method disclosed herein.

TABLE 3
COMPARISON OF VARIOUS REASONING TECHNOLOGIES

| | In- | | | | En- |
|---|---|---|---|---|---|
| | context | | | | hanced |
| | Learn- | SFT, | | Al- | Reason- |
| | ing | LoRA | MCTS-α | phaLLM | ing |
| Data-free | No | No | Yes | Yes | Yes |
| Multiple candidates | No | No | No | No | Yes |
| at each step | | | | | |
| Finetuning-free | Yes | No | No | No | Yes |
| (consistency on | | | | | |
| other domains) | | | | | |
| Query augmentation | No | No | No | No | Yes |
| (reasoning forest) | | | | | |
| Result consistency | No | No | No | No | Yes |

In this application, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present application.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In this application, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). For example, “at least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

The following documents are incorporated herein by reference in their entirety:
[1] Sun, Jiankai, et al. “A survey of reasoning with foundation models.” arXiv preprint arXiv: 2312.11562 (2023).
[2] Orseau, Laurent, et al. “Single-agent policy tree search with guarantees.” Advances in Neural Information Processing Systems 31 (2018).
[3] Feng, Xidong, et al., “Alphazero-like tree-search can guide large language model decoding and training.” arXiv preprint arXiv: 2309.17179 (2023).
[4] Tian, Ye, et al., “Toward Self-Improvement of LLMs via Imagination, Searching, and Criticizing.” arXiv preprint arXiv: 2404.12253 (2024).
[5] Kang, Jikun, et al., “Mindstar: Enhancing Math Reasoning in pretrained LLMs at Inference time”. arXiv preprint arXiv: 2405.16265 (2024).

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method comprising:
generating one or more queries from an input question;
generating one or more outputs for the one or more queries, each output corresponding to a respective one of the one or more queries; and
outputting an answer based on the one or more outputs;
wherein said generating the one or more outputs for the one or more queries comprises: for each query of the one or more queries,
forming a reasoning tree with the query being a root node and a current node,
generating one or more candidate nodes by inputting a reasoning path from the root node to the current node into a foundation model (FM), the one or more candidate nodes being appended to the current node as one or more leaf nodes of the reasoning tree,
searching the reasoning tree using an artificial intelligence (AI) model to select a leaf node from the reasoning tree as the current node, and
repeating said generating the one or more candidate nodes and said searching the reasoning tree until a termination condition is met, and
using an updated reasoning path from the root node to the current node as the output for the query.

2. The method of claim 1, wherein said generating the one or more queries from an input question comprises:
rephrasing the input question into one or more rephrased queries; and
wherein the one or more outputs comprise the input question and the one or more rephrased queries.

3. The method of claim 2, wherein said outputting the answer based on the one or more outputs comprises:
outputting the answer as one of the one or more outputs selected based on scoring of the one or more outputs or selected using a majority voting method based on the one or more outputs.

4. The method of claim 1, wherein said generating the one or more candidate nodes comprises:
generating a plurality of candidate nodes by repeatedly inputting the reasoning path from the root node to the current node into the FM and by using a predefined or predetermined template.

5. The method of claim 1, wherein said searching the reasoning tree comprises:
scoring each of the plurality of candidate nodes using a process-supervised reward model (PRM) or a reinforcement learning model.

6. The method of claim 1, wherein said searching the reasoning tree comprises:
searching the reasoning tree using a beam search method or a Levin tree search (LevinTS) method.

7. One or more processors functionally connected to one or more non-transitory, computer-readable storage media comprising computer-executable instructions, wherein the instructions, when executed, cause the one or more processors to perform the method of claim 1.

8. The one or more processors of claim 7, wherein said generating the one or more queries from an input question comprises:
rephrasing the input question into one or more rephrased queries; and
wherein the one or more outputs comprise the input question and the one or more rephrased queries.

9. The one or more processors of claim 8, wherein said outputting the answer based on the one or more outputs comprises:
outputting the answer as one of the one or more outputs selected based on scoring of the one or more outputs or selected using a majority voting method based on the one or more outputs.

10. The one or more processors of claim 7, wherein said generating the one or more candidate nodes comprises:
generating a plurality of candidate nodes by repeatedly inputting the reasoning path from the root node to the current node into the FM and by using a predefined or predetermined template.

11. The one or more processors of claim 7, wherein said searching the reasoning tree comprises:
scoring each of the plurality of candidate nodes using a process-supervised reward model (PRM) or a reinforcement learning model.

12. The one or more processors of claim 7, wherein said searching the reasoning tree comprises:
searching the reasoning tree using a beam search method or a Levin tree search (LevinTS) method.

13. One or more non-transitory computer-readable storage media comprising computer-executable instructions, wherein the instructions, when executed, cause one or more circuits to perform the method of claim 1.

14. The one or more non-transitory computer-readable storage media of claim 13, wherein said generating the one or more queries from an input question comprises:
rephrasing the input question into one or more rephrased queries; and
wherein the one or more outputs comprise the input question and the one or more rephrased queries.

15. The one or more non-transitory computer-readable storage media of claim 14, wherein said outputting the answer based on the one or more outputs comprises:
outputting the answer as one of the one or more outputs selected based on scoring of the one or more outputs or selected using a majority voting method based on the one or more outputs.

16. The one or more non-transitory computer-readable storage media of claim 13, wherein said generating the one or more candidate nodes comprises:
generating a plurality of candidate nodes by repeatedly inputting the reasoning path from the root node to the current node into the FM.

17. The one or more non-transitory computer-readable storage media of claim 13, wherein said generating the one or more candidate nodes comprises:
generating a plurality of candidate nodes by repeatedly inputting the reasoning path from the root node to the current node into the FM and by using a predefined or predetermined template.

18. The one or more non-transitory computer-readable storage media of claim 13, wherein said generating the plurality of candidate nodes comprises:
in each of said repeatedly inputting, inputting the reasoning path from the root node to the current node into the FM to generate one candidate node; and
if, in one of said repeatedly inputting, more than one node is generated, using one or more regular expressions to selected one of the generated more than one mode as said one candidate node.

19. The one or more non-transitory computer-readable storage media of claim 13, wherein said searching the reasoning tree comprises:
scoring each of the plurality of candidate nodes using a process-supervised reward model (PRM) or a reinforcement learning model.

20. The one or more non-transitory computer-readable storage media of claim 13, wherein said searching the reasoning tree comprises:
searching the reasoning tree using a beam search method or a Levin tree search (LevinTS) method.
